(19) United States
(12) Patent Application Publication
(10) Pub. No.: US 2003/0156094 A1
(43) Pub. Date: Aug. 21, 2003

(54) Angular adjustment device for a plane display

(76) Inventors: Yeong Kuen Chen, Tainan Hsien (TW); Bo-Xun WU, Tainan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/254,230

(22) Filed: Sep. 25, 2002

(30) Foreign Application Priority Data
Feb. 20, 2002 (TW) 91202044

(51) Int. Cl. G09G 5/00

(52) U.S. Cl. 345/156

(57) ABSTRACT

An angular adjustment device for a plane display. The angular adjustment device includes a supporting arm extending from the central region of an arched base and having branch arms to mount the plane display, and a sliding member movably connected to the extending portion of the arched base and sliding thereon so that the observation angle of the plane display can be changed without using a hinge.

### BACKGROUND OF THE INVENTION

1. Field of the Invention

The present invention relates to an angular adjustment device for a plane display, and more particularly, to an angular adjustment device including an arched base with a sliding member mounted thereon to change the observation angle of the plane display.

2. Description of the Related Art

Liquid crystal displays (LCD) are popular plane displays. Compared to cathode ray tube displays (CRT), LCDs have advantages of lower radiation, lower power consumption and smaller profile. FIG. 1 is a drawing of a conventional LCD, including an LCD panel 11, an arm 12, a shaft 13, and a base 14. The arm 12 supports the LCD panel and is rotatably connected to the base 14 by the shaft 13. Thus, users can change the vertical position and the observation angle of the LCD panel 11.

Previously, the shaft 13 has mostly been achieved by a hinge to change the observation angle, but hinges are complex and costly.

### SUMMARY OF THE INVENTION

Accordingly, an object of the present invention is to provide an angular adjustment device for a plane display without using a hinge. The angular adjustment device provides stable support to the plane display and has simple structure so that the cost is reduced

The present invention provides an angular adjustment device for a plane display. The angular adjustment device comprises a supporting arm extending from the central region of an arched base and having branch arms to mount the plane display, and a sliding member movably connected to the extending portion of the arched base and sliding thereon so that the observation angle of the plane display can be changed without using a hinge.

The present invention also provides a plane display. The plane display includes a plane display panel supported by an arched base, a supporting arm extending from the central region of an arched base and having branch arms to mount the plane display, and a sliding member movably connected to the extending portion of the arched base and sliding thereon so that the observation angle of the plane display can be changed without using a hinge.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 (Prior Art) is a drawing of a conventional LCD;

FIG. 2A is a chart of the angular adjustment device of the present invention secured at the first inclination angle;

FIG. 2B is a chart of the angular adjustment device of the present invention secured at the second inclination angle;

FIG. 3 is a perspective view of the angular adjustment device of the present invention;

FIG. 4A is a front view of the angular adjustment device in FIG. 3;

FIG. 4B is a side view of the angular adjustment device in FIG. 3;

FIG. 4C is a bottom view of the angular adjustment device in FIG. 3;

FIG. 4D is a front view of the plane spring in FIG. 4C;

FIG. 4E is another perspective view of the angular adjustment device of the present invention;

FIG. 5A is a side view of the plane display with the angular adjustment device of the present invention secured at the first observation angle; and

FIG. 5B is a side view of the plane display with the angular adjustment device of the present invention secured at the second observation angle;

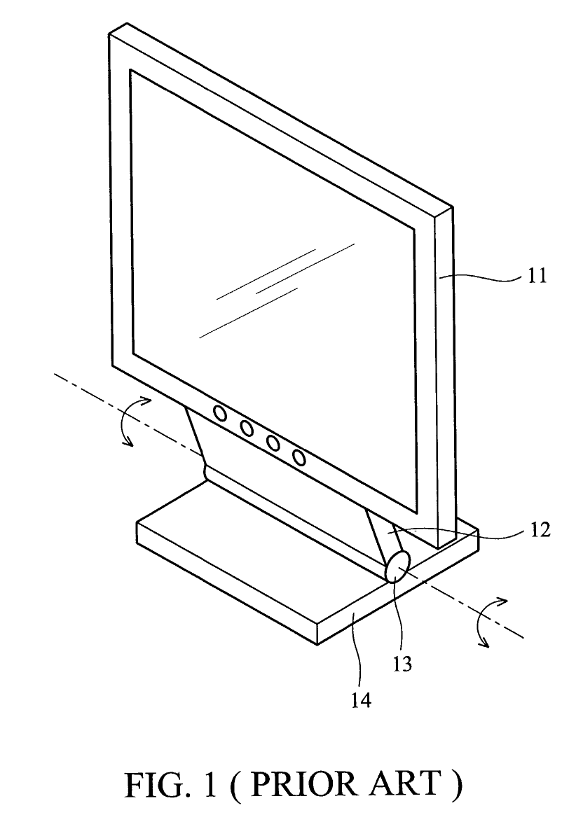

### DETAILED DESCRIPTION OF THE INVENTION

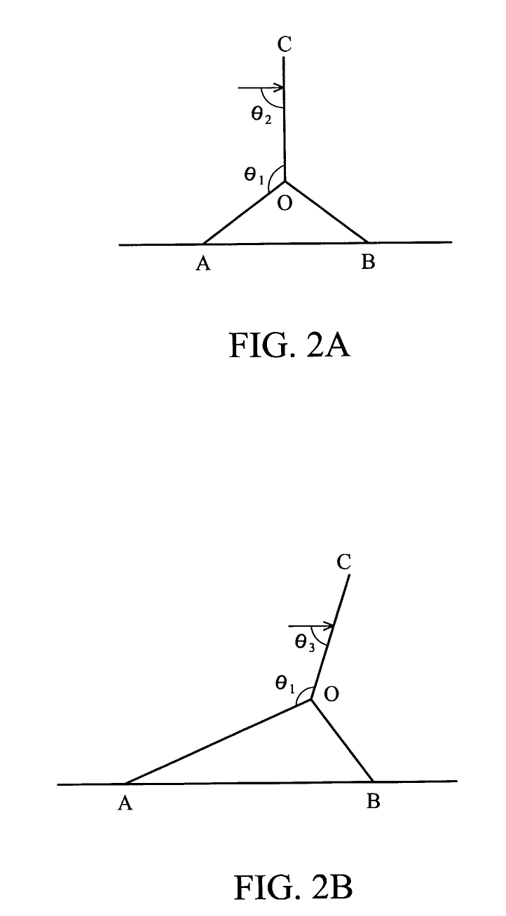

The present invention provides an angular adjustment device to change the observation angle of a plane display. FIG. 2A is a chart of the angular adjustment device of the present invention disposed at the first inclination angle. In FIG. 2A, the triangle O-A-B represents the base of a plane display. The line O-C represents a plane display panel. θ1 is a fixing angle between the base and the plane display, and θ2 represents a first observation angle. Because the angle θ1 between the base and the plane display is fixed, and the length of the line O-B is fixed, the observation angle θ2 is changed when the line O-A becomes longer or shorter. FIG. 2B is a chart of the angular adjustment device of the present invention disposed at the second inclination angle. In FIG. 2B, the line O-A of the triangle O-A-B becomes longer, and the inclination angle of the plane display is changed, and the observation angle becomes θ3.

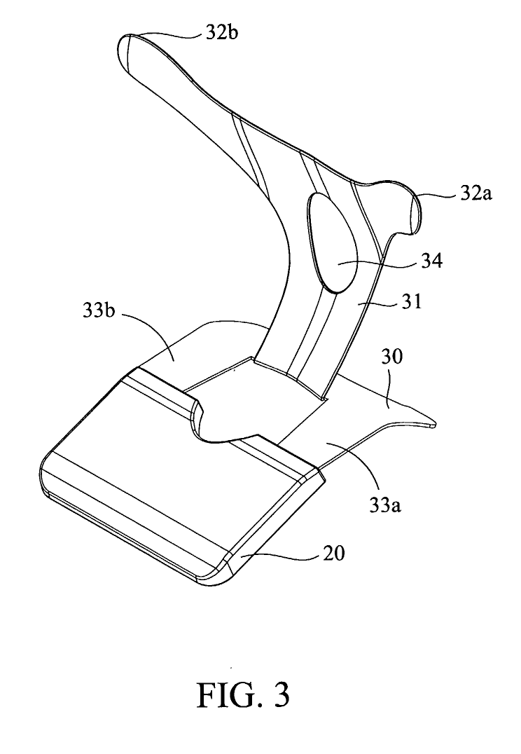

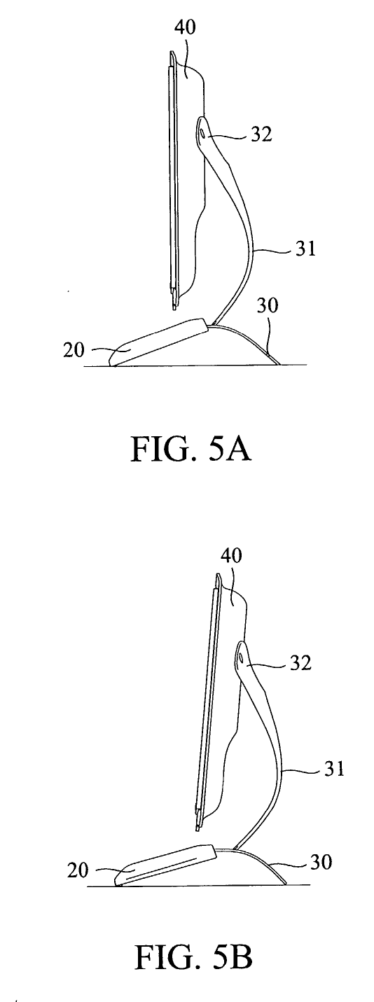

FIG. 3 is a perspective view of the angular adjustment device of the present invention. In FIG. 3, the angular adjustment device includes an arched base 30, a supporting arm 31 and a sliding member 20. The arched base 30 and the supporting arm 31 are welded or an integral plane of strengthened plastic, metal or alloy, such as aluminum, steel or Mg/Al alloy. The supporting arm 31 extends from the center portion of the arched base and has two branch arms 32a, 32b. A plane display panel (as shown in FIG. 5A) is fixed to the branch arms by the screws or welds. In FIG. 3, the arched base 30 has an extending portion 33a, 33b. The sliding member 20 is connected to the extending portion 33a, 33b, and slides along the extending portion 33a, 33b. Accordingly, the inclination angle of the supporting arm 31 can be changed by moving the position of the sliding member 20 on the extending portion 33a, 33b. Furthermore, the sliding member 20 is made of strengthened plastic, metal or alloy, such as aluminum, steel or Mg/Al alloy.

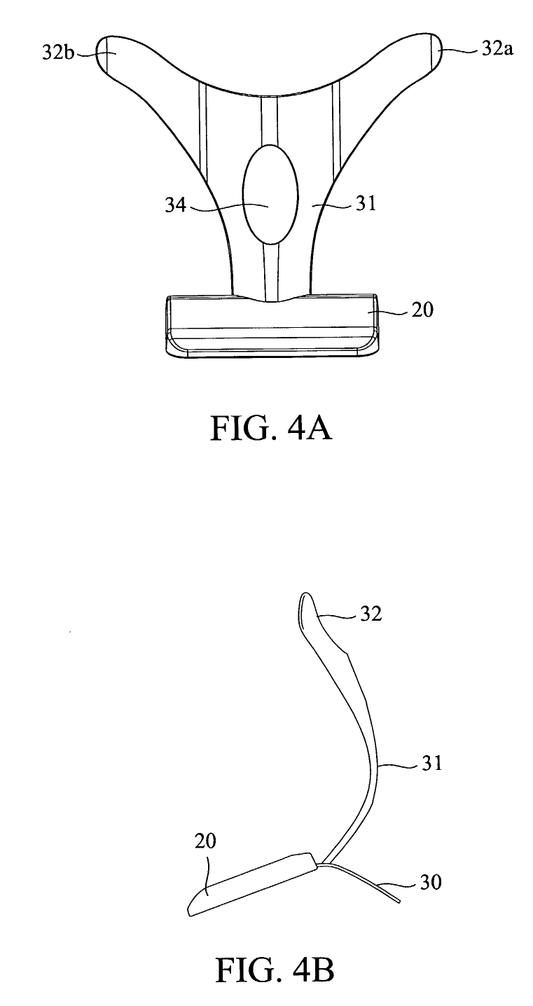

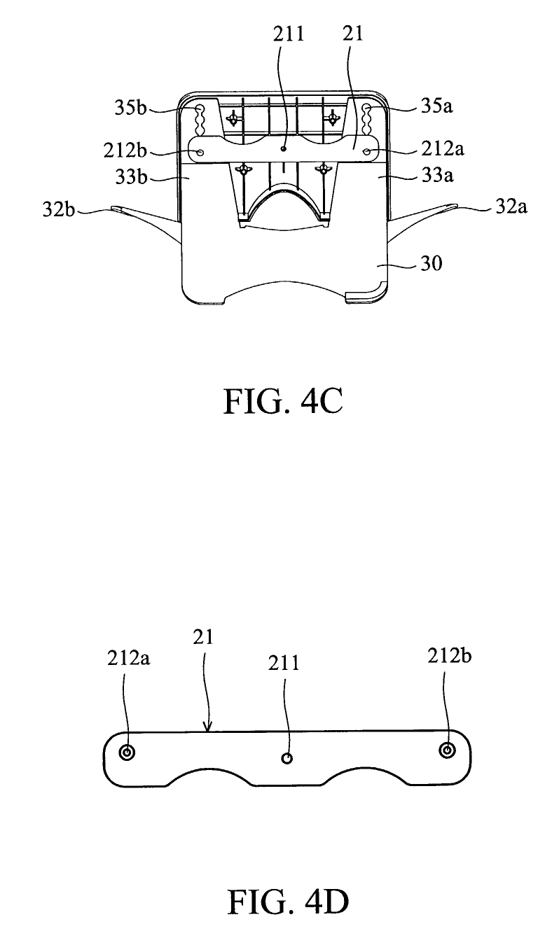

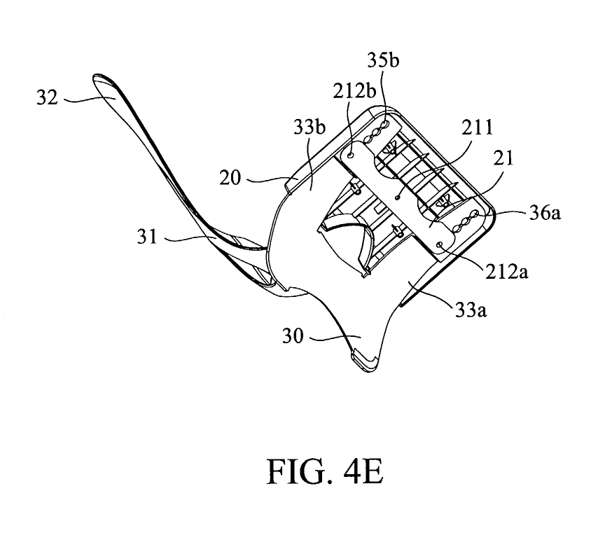

In FIG. 4A and 4B, the supporting arm 31 of the present invention is an arched plane with an opening 34 at the central part through which can pass wires of the plane display. The branch arms 32a, 32b extend from of the supporting arm 31 to mount the plane display by screws or welds.

In order to secure the sliding member 20 to the extending portion 33a, 33b of the arched base 30, the sliding member 20 has a fixing assembly to secure the extending portion 33a, 33b tightly at a plurality of positions so that the sliding member 20 does not move from the weight of the plane display.

FIG. 4C and 4E are the bottom view of the angular adjustment device. The fixing assembly of the sliding member 20 is a plane spring 21 as shown in FIG. 4D. The plane spring 21 is bolted at the central part of the bottom surface of the sliding member 20 and presses the extending portion 33a, 33b so that the sliding member 20 is fixed to the extending portion 33a, 33b. The plane spring 21 has two protrusions 212a, 212b at both ends. The protrusions 212a, 212bmatch the grooves 35a, 35b of the extending portion 33a, 33b and slide along the grooves 35a, 35b. The grooves 35a, 35b have some fixed positions. When pulling or pushing the sliding member 20 to another fixed position, the inclination angle of the angular adjustment is changed.

FIG. 5A shows a plane display 40 with the angular adjustment device at its first inclination angle. In FIG. 5A, the plane display 40 is mounted to the branch arms 32. The observation angle is θ2 as shown in FIG. 2A. FIG. 5B shows a plane display 40 with the angular adjustment device at its second inclination angle. In FIG. 5B, when pulling the sliding member 20 into another fixed position, the inclination angle of the plane display 40 is changed, and the observation angle becomes θ3 as shown in FIG. 2B.

According to the angular adjustment device of the present invention, the observation angle can be changed without using hinges. Thus, the cost of the entire display is reduced.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An angular adjustment device for a plane display, comprising:
an arched base, having an extending portion;
a supporting arm extending from a central region of the arched base, wherein the supporting arm has at least one branch arm to mount the plane display; and
a sliding member, movably connected to the extending portion and sliding thereon.

2. The angular adjustment device as claimed in claim 1, wherein the arched base and the supporting arm are integral.

3. The angular adjustment device as claimed in claim 1, wherein the arched base and the supporting arm are welded together.

4. The angular adjustment device as claimed in claim 1, wherein the extending portion has a plurality of grooves.

5. The angular adjustment device as claimed in claim 1, wherein the arched base and the supporting arm are made of plastic.

6. The angular adjustment device as claimed in claim 1, wherein the arched base and the supporting arm are made of metal.

7. The angular adjustment device as claimed in claim 1, wherein the arched base and the supporting arm are made of alloy.

8. The angular adjustment device as claimed in claim 1, wherein the sliding member is made of plastic.

9. The angular adjustment device as claimed in claim 1, wherein the sliding member is made of metal.

10. The angular adjustment device as claimed in claim 1, wherein the sliding member is made of alloy.

11. The angular adjustment device as claimed in claim 1, wherein the sliding member has a fixing assembly to fix the sliding member at a plurality of positions on the extending portion.

12. The angular adjustment device as claimed in claim 11, wherein the fixing assembly includes a plane spring bolted on the sliding member, and the plane spring presses the extending portion so that the sliding member is fixed to the extending portion.

13. The angular adjustment device as claimed in claim 12, wherein the plane spring has two protrusions sliding along the grooves of the extending portion.

14. A plane display with an angular adjustment device, comprising:
a plane display panel;
an arched base, having an extending portion;
a supporting arm extending from a central region of the arched base, having at least one branch arm to mount the plane display; and
a sliding member, movably connected to the extending portion and sliding thereon.

15. The angular adjustment device as claimed in claim 14, wherein the arched base and the supporting arm are integral.

16. The angular adjustment device as claimed in claim 14, wherein the arched base and the supporting arm are welded together.

17. The angular adjustment device as claimed in claim 14, wherein the extending portion has a plurality of grooves.

18. The angular adjustment device as claimed in claim 14, wherein the arched base and the supporting arm are made of plastic.

19. The angular adjustment device as claimed in claim 14, wherein the arched base and the supporting arm made of are metal.

20. The angular adjustment device as claimed in claim 14, wherein the arched base and the supporting arm made of are alloy.

21. The angular adjustment device as claimed in claim 14, wherein the sliding member is made of plastic.

22. The angular adjustment device as claimed in claim 14, wherein the sliding member is made of metal.

23. The angular adjustment device as claimed in claim 14, wherein the sliding member is made of alloy.

24. The angular adjustment device as claimed in claim 14, wherein the sliding member has a fixing assembly to fix the sliding member at a plurality of positions on the extending portion.

25. The angular adjustment device as claimed in claim 24, wherein the fixing assembly includes a plane spring bolted on the sliding member, and the plane spring presses the extending portion so that the sliding member is fixed to the extending portion.

26. The angular adjustment device as claimed in claim 25, wherein the plane spring has two protrusions sliding along the grooves of the extending portion.
